(19) United States
(12) Patent Application Publication
(10) Pub. No.: US 2025/0033490 A1
(43) Pub. Date: Jan. 30, 2025

(54) SEVEN-SWITCH INDIRECT MATRIX CONVERTER WITH PASSIVE SECONDARY CIRCUIT

(71) Applicants: BorgWarner Inc., Aubum Hills, MI (US); BOARD OF TRUSTEES OF MICHIGAN STATE UNIVERSITY, East Lansing, MI (US)

(72) Inventors: Luca Di Carlo, Royal Oak, MI (US); Woongkul Lee, Oekmos, MI (US); Brian C. Wightman, Davisburg, MI (US)

(21) Appl. No.: 18/226,389

(22) Filed: Jul. 26, 2023

(51) Int. Cl. B60L 53/10; B60L 55/00; H02M 7/219

(52) U.S. Cl. CPC B60L 53/11; B60L 55/00; H02M 7/219; B60L 2210/30

(57) ABSTRACT

A direct current (DC) fast charger for charging batteries of electric vehicles (EVs) that includes a primary circuit, with seven bidirectional switches, electrically linked to a primary wire of a transformer and configured to receive alternating current (AC) voltage; and a secondary circuit, including a plurality of diodes arranged to rectify AC voltage into DC voltage, that is electrically linked to a secondary wire of the transformer, such that the DC fast charger unidirectionally converts AC voltage received at the primary circuit into DC voltage output by the secondary circuit.

### GOVERNMENT INTEREST

This invention was made with government support under the DE-EE0009869 contract, awarded by the United States Department of Energy, Energy Efficiency & Renewable Energy EE-1 Office. The U.S. Government has certain rights in the invention.

### TECHNICAL FIELD

The present application relates to electric vehicles (EVs) and, more particularly, to chargers for charging EVs.

### BACKGROUND

Modern vehicles are increasingly propelled at least partially or wholly by electric motors. The vehicles, often referred to as electric vehicles (EVs), include a vehicle battery and one or more electric motors that drive the vehicle wheels. The vehicle batteries are periodically coupled to a battery charger. As motorists purchase increasing quantities of EVs, they will want to be able to charge the vehicle batteries relatively quickly. Therefore, faster and more efficient vehicle battery chargers are helpful.

### SUMMARY

In one implementation, a direct current (DC) fast charger for charging batteries of electric vehicles (EVs) that includes a primary circuit, with seven bidirectional switches, electrically linked to a primary wire of a transformer and configured to receive alternating current (AC) power; and a secondary circuit, including a plurality of diodes arranged to rectify AC power into DC power, that is electrically linked to a secondary wire of the transformer, such that the DC fast charger unidirectionally converts AC power received at the primary circuit into DC power output by the secondary circuit.

In another implementation, a DC fast charger for charging batteries of EVs includes a primary circuit, including seven bidirectional switches, electrically linked to a primary wire of a transformer and configured to receive AC power; a secondary circuit, including a full-bridge rectifier comprising passive electrical components arranged to rectify AC power into DC power, that is electrically linked to a secondary wire of the transformer, wherein the DC fast charger unidirectionally converts AC power received at the primary circuit into DC power output by the secondary circuit.

In yet another implementation, a DC fast charger for charging batteries of EVs includes a primary circuit, including seven bidirectional switches, electrically linked to a primary wire of a transformer and configured to receive AC power; a shim inductor electrically connected to the primary circuit; a secondary circuit, including a full-bridge rectifier comprising passive electrical components arranged to rectify AC power into DC power and a capacitor, that are electrically linked to a secondary wire of the transformer, wherein the DC fast charger unidirectionally converts AC power received at the primary circuit into DC power output by the secondary circuit.

### BRIEF DESCRIPTION OF THE DRAWINGS

FIG. 1 is a block diagram depicting an implementation of an electric vehicle;

FIG. 2 is a circuit diagram depicting an implementation of a DC fast charger and a control system; and

FIGS. 3a-3f are circuit diagrams depicting an implementation of a DC fast charger.

### DETAILED DESCRIPTION

A seven-switch indirect matrix converter DC fast charger for vehicular applications is unidirectional such that it converts electric power received from a grid and supplies the converted power to an electric vehicle (EV) to charge the vehicle (G2V). The DC fast charger includes a primary circuit having a seven-switch topology including switches that are bidirectional. The secondary circuit of the DC fast charger can use a passive diode bridge rather than actively-controlled switches, such as those having a gate that regulates conductivity, thereby reducing cost relative to other designs. The electrical power supplied to the DC fast charger is three-phase AC electrical power.

The seven-switch indirect matrix converter or DC fast charger, can deliver unidirectional electrical power from the three-phase grid at the primary circuit to the secondary circuit by controlling the modulation of a semi-square wave. In one implementation, the three-phase AC voltage grid period, measured at 1/50- 1/60 seconds(s), can be divided into a plurality, for example six sectors each delineated by two consecutive AC zero voltage inflection points. In each sector, the phase with the highest absolute value can be designated the leading phase, and the other two phases can be used to apply a controlled voltage to the primary circuit. The electrical current applied to the primary circuit can then include three different duty cycles each corresponding to a phase. Dₓ can identify the duty cycle of voltage Vₐ−V_{b}, Dy can identify the duty cycle of voltage Vₐ−V_{c}, and D₀ can identify the duty cycle of a freewheeling phase when the seventh switch is active. The seventh switch can facilitate conduction loss reduction of 50% during freewheeling periods under light electrical load. The electrical current applied to the primary circuit can be converted to DC power by the diode bridge of the secondary circuit. The secondary circuit can include an inductor and a capacitor to smooth the DC electrical output from the secondary circuit.

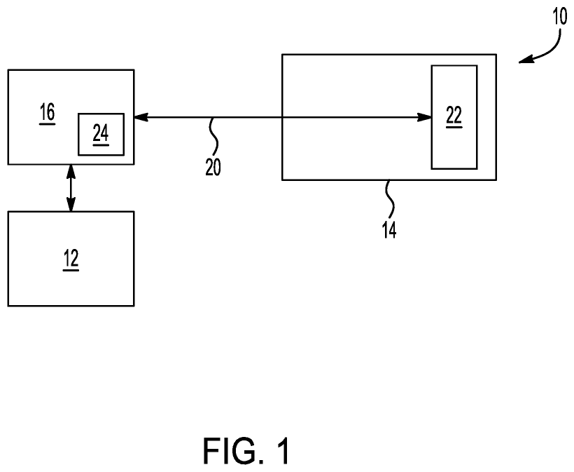

Turning to FIG. 1, an implementation of an electrical system 10 is shown including an electrical grid 12 and an electric vehicle (EV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS alternating current three-phase 50-60 Hz. However, this voltage range can be different.

An EV charging station, referred to here as a DC fast charger 16, can receive AC electrical power from the grid 12, rectify the AC electrical power into DC electrical power, and provide the DC electrical power to the EV 14. The DC fast charger 16 can be geographically fixed, such as a charging station located in a vehicle garage or in a vehicle parking lot. The DC fast charger 16 can include an input terminal that receives the AC electrical power from the grid 12 and communicates the AC electrical power to the EV battery 22 directly, bypassing an on-board vehicle battery charger 18 included on the EV 14. An electrical cable 20 can detachably connect with an electrical receptacle on the EV 14 and electrically link the DC fast charger 16 with the EV 14 so that DC electrical power can be communicated between the DC fast charger 16 and the EV battery 22. The DC fast charger 16 can receive 480 VAC from the grid 12 and have a power rating of 60-360 kW provided to the EV 14. This type of DC fast charging may be referred to as Level 3 EV charging. However, the EV charging station can be using different standards. The term “electric vehicle” or “EV” can refer to vehicles that are propelled, either wholly or partially, by electric motors. EV can refer to electric vehicles, plug-in electric vehicles, hybrid-electric vehicles, and battery powered vehicles. The EV battery 22 can supply DC electrical power controlled by power electronics to the electric motors that propel the EV. The EV battery 22 or batteries are rechargeable and can include lead-acid batteries, nickel cadmium (NiCd), nickel metal hydride, lithium-ion, and lithium polymer batteries. A typical range of vehicle battery voltages can range from 100 to 1000V of DC electrical power (VDC). A control system, implemented as computer-readable instructions executable by a microprocessor, can be stored in non-volatile memory and called on to control functionality of the DC fast charger 16. This will be discussed in more detail below.

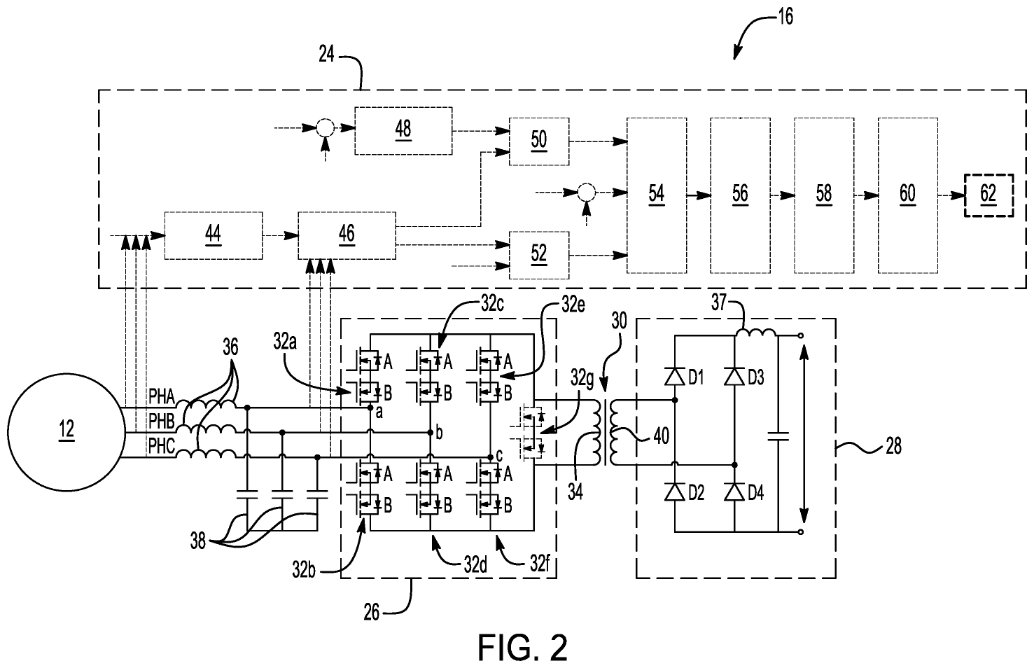

FIG. 2 depicts an implementation of the DC fast charger 16 and a control system 24 used with the charger 16. The DC fast charger 16 is an indirect matrix converter that includes a primary circuit 26 and a secondary circuit 28 inductively coupled together via a transformer 30. The primary circuit 26 includes seven switches 32 electrically coupled to the grid 12 and a primary winding 34 of the transformer 30. The switches 32 can be implemented using bipolar junction transistors (BJTs) or field effect transistors (FETs), such as insulated gate bipolar transistors (IGBTs), metal-oxide-semiconductor field effect transistors (MOSFETs), or gallium nitride transistors (GaN). The switches 32 can be bidirectional or reverse-blocking such that they are four-quadrant switches capable of conducting positive or negative on-state current and blocking positive or negative off-state voltage. A number of different circuit configurations can be used to implement such a switch any of which could be implemented in the DC fast charger described herein. In one implementation, each switch 32 includes an A side MOSFET and a B side MOSFET with gates that can be electrically connected to a microprocessor. Six switches 32a-f can be electrically coupled to three legs of the electrical grid PHA, PHB, PHC and nodes a, b, c of the primary circuit 26. Voltages of these three legs can be identified as Vₐ, V_{b}, and V_{c}. A seventh switch 32g can be wired in parallel with switches 32e and 32f, and with the primary winding 34 of the transformer 32. Inductors 36 and bulk capacitance 38 can be electrically connected to the legs PHA, PHB, PHC of the grid 12.

The secondary circuit 28 is electrically connected to a secondary winding 40 of the transformer 32. The circuit 28 includes a passive full-bridge rectifier that can be implemented using four diodes D1-D4. The diodes in the secondary circuit 28 can be implemented using any one of a variety of different types of diodes. The secondary circuit 28 can include An electrical filter with an inductor and a capacitor that smooths the output DC voltage. The EV battery 22 can be electrically connected to the diodes such that the secondary circuit 28 passively rectifies AC voltage induced through the secondary winding 40 into DC voltage applied to the EV battery 22.

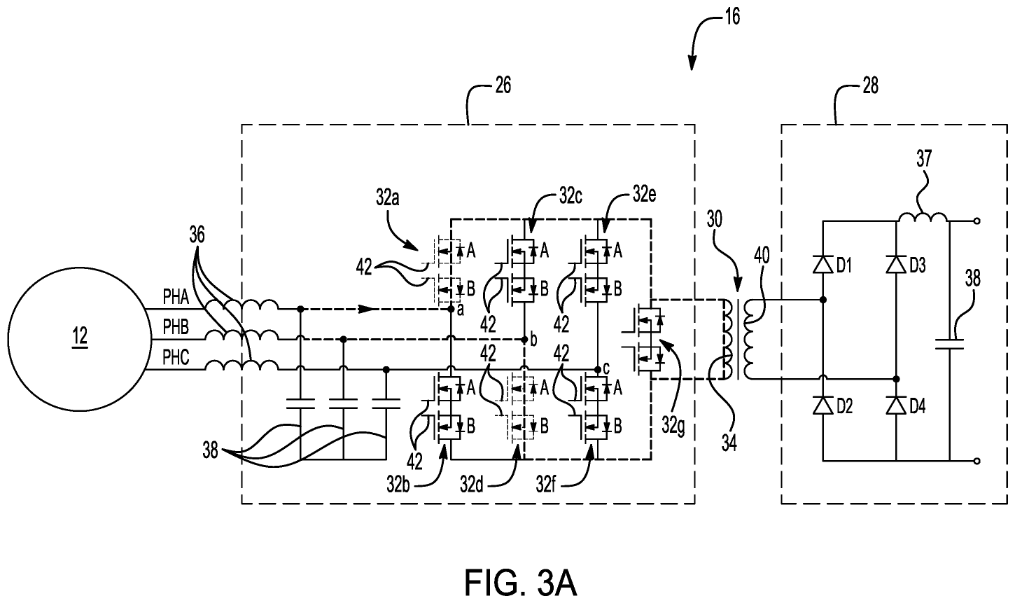

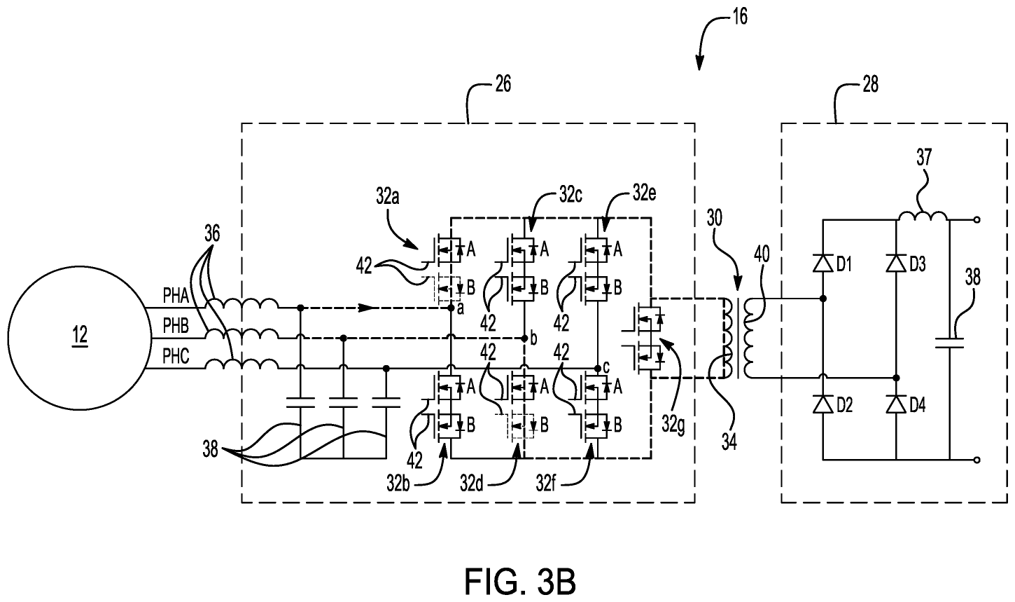

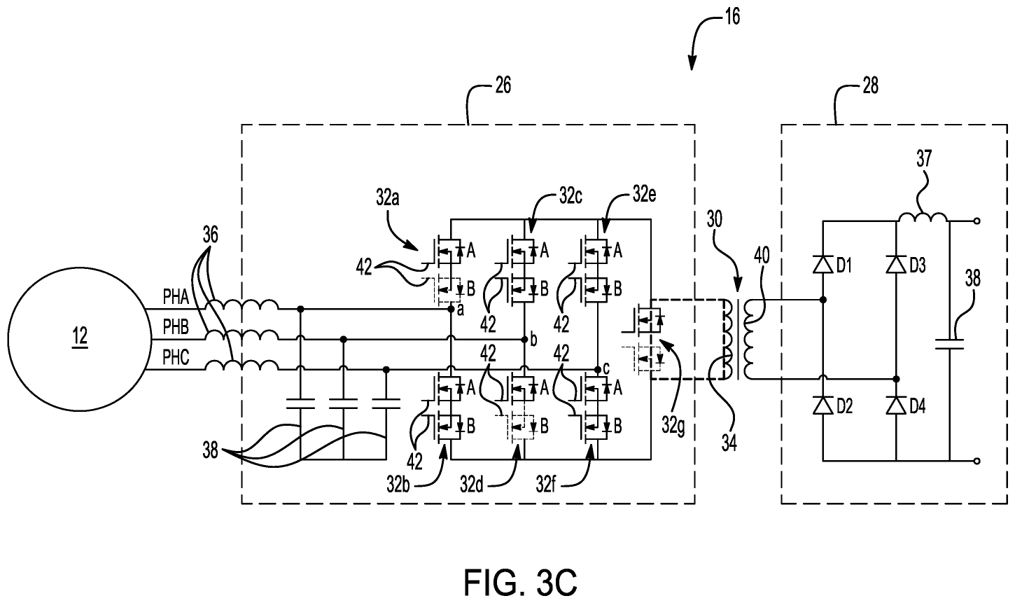

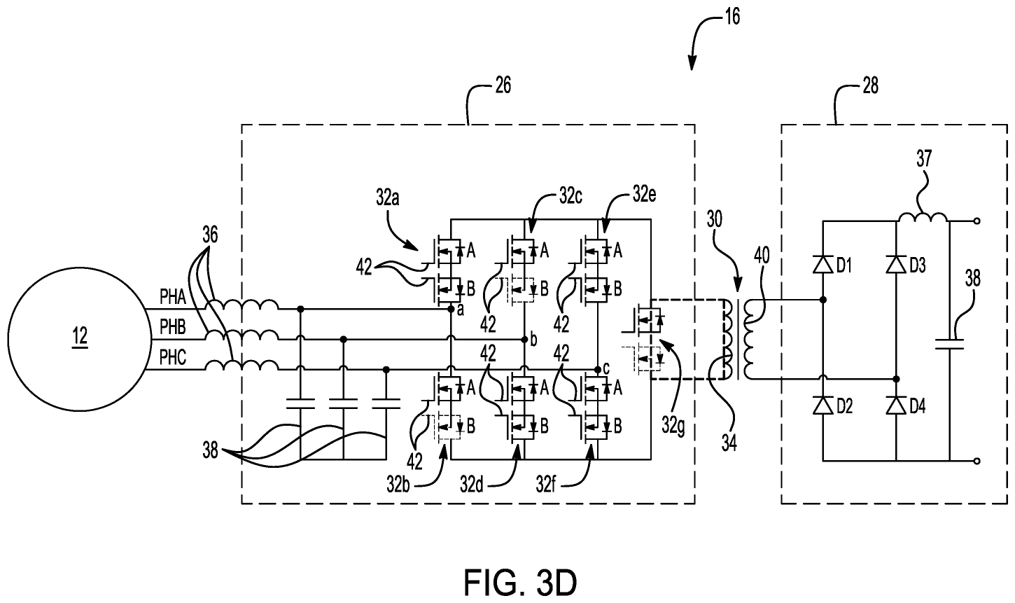

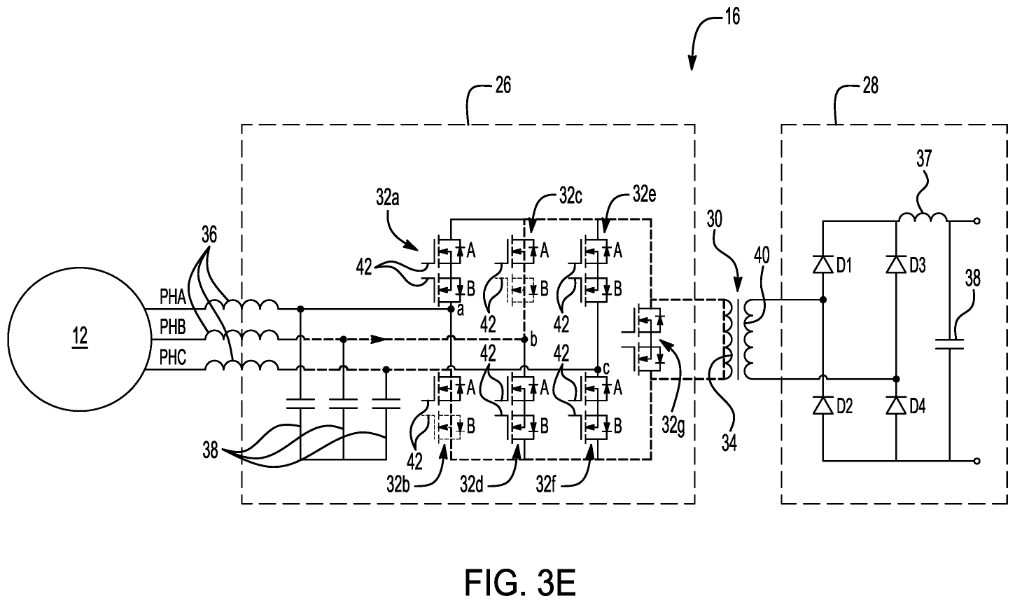

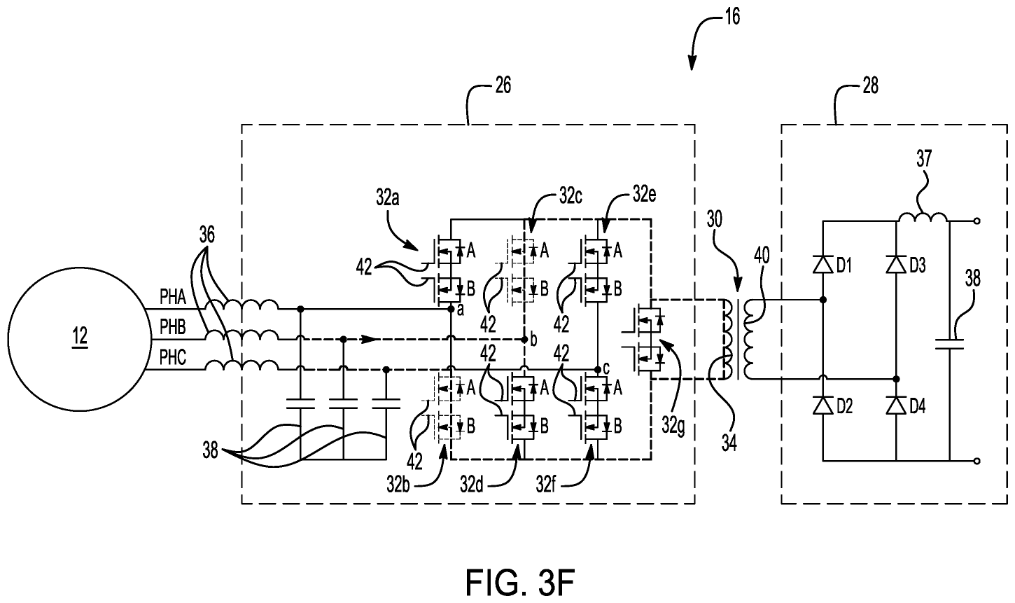

The control system 24 can be implemented using a microprocessor having outputs electrically connected to the gates 42 of the switches 32 in the DC fast charger 16. An implementation of the control system 24 is shown in FIG. 3. The control system 24 includes a phase locked loop 44 electrically connected to the three legs PHA, PHB, PHC of the grid 12. The phase locked loop 44 can be used to determine the phase (θ_{grid}) of the AC voltage received from the grid 12. The phase can then be provided to a dq transformation block 46 to obtain a rotating reference frame (d_{q}) signal. A voltage controller 48 can generate I_{q}* using a target DC voltage level subtracted from a measured DC voltage level (V_{dc} *−V_{dc}). I_{q}* can be provided to a first current controller 50 along with d_{q} to generate V_{q} *. Iₐ* can be provided to a second current controller 52 along with d_{q} to generate V_{d}*. A dq-abc block 54 can receive Vq*, Vd*, and the phase (θ_{grid}), minus an angular offset, to a voltage source inverter (VSI) space vector modulation (SVM) block 56. The VSI SVM block 56 can provide output to a current source inverter (CSI) SVM block 58, which can provide output to a matrix SVM block 60. Gate signals to can be generated at block 62 and electrically communicated to the gates of the switches 32 to control the conductive state.

The DC fast charger 16 can control the primary circuit 26 to induce the flow of AC current in the transformer 30. The change in the conductivity of the switches 32 included in the primary circuit 26 is shown in FIGS. 3a-f. An initial switch state of the primary circuit 26 is shown in FIG. 3a where the A and B MOSFETs of switches 32a and 32d are initially conductive to flow current through legs A and B. The current path and switch conductivity is shown with arrows and/or hashed lines. A first switching step can render the A side MOSFETs of switches 32a and 32d non-conductive as shown in FIG. 3b. A second switching step can render the B side MOSFET of the seventh switch 32g conductive as shown in FIG. 3c. A third switching step is shown in FIG. 3d, such that the B side MOSFET of switch 32a is rendered non-conductive, the B side MOSFET of switch 32c is rendered conductive, and the B side MOSFET of switch 32d is rendered non-conductive. The conductive state change of switches 32a, 32c, and 32d can be considered soft switching events as they are made absent the presence of electrical current. FIG. 3e depicts a fourth switching state in which the B side MOSFET of switch 32g is rendered non-conductive. A fifth switching state is shown in FIG. 3f in which the A side MOSFET of switch 32c is rendered conductive and the A side of switch 32b is rendered conductive. The control system 24 can then return the conductive state of the primary circuit 26 to the initial switch state and repeat the five switching states to change the frequency of the AC voltage received from the grid 12.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A direct current (DC) fast charger for charging batteries of electric vehicles (EVs), comprising:
a primary circuit, including seven bidirectional switches, electrically linked to a primary wire of a transformer and configured to receive alternating current (AC) voltage; and
a secondary circuit, including a plurality of diodes arranged to rectify AC voltage into DC voltage, that is electrically linked to a secondary wire of the transformer, wherein the DC fast charger unidirectionally converts AC voltage received at the primary circuit into DC voltage output by the secondary circuit.

2. The DC fast charger recited in claim 1, further comprising a control system, electrically linked to the seven bidirectional switches, that changes the frequency of the AC voltage received from the power grid in five switch state changes.

3. The DC fast charger recited in claim 1, wherein the primary circuit uses the primary wire of the transformer as a leakage inductor.

4. The DC fast charger recited in claim 1, wherein the secondary circuit includes an inductor and a capacitor.

6. The DC fast charger recited in claim 1, further comprising a control system that divides three-phase AC voltage received at the primary circuit into a plurality of sectors each defined by two consecutive inflection points at which AC voltage equals zero.

7. The DC fast charger recited in claim 6, wherein the control system identifies a sector having the highest absolute voltage.

8. A direct current (DC) fast charger for charging batteries of electric vehicles (EVs), comprising:
a primary circuit, including seven bidirectional switches, electrically linked to a primary wire of a transformer and configured to receive alternating current (AC) voltage;
a secondary circuit, including a full-bridge rectifier comprising passive electrical components arranged to rectify AC voltage into DC voltage, that is electrically linked to a secondary wire of the transformer, wherein the DC fast charger unidirectionally converts AC voltage received at the primary circuit into DC voltage output by the secondary circuit.

9. The DC fast charger recited in claim 8, further comprising a control system, electrically linked to the seven bidirectional switches, that changes the frequency of the AC voltage received from the power grid in five switch state changes.

10. The DC fast charger recited in claim 8, wherein the primary circuit uses the primary wire of the transformer as a leakage inductor.

11. The DC fast charger recited in claim 8, wherein the secondary circuit includes an inductor and a capacitor.

12. The DC fast charger recited in claim 8, further comprising a control system that divides three-phase AC voltage received at the primary circuit into a plurality of sectors each defined by two consecutive inflection points at which AC voltage equals zero.

13. The DC fast charger recited in claim 12, wherein the control system identifies a sector having the highest absolute voltage.
